(19) United States
(12) Patent Application Publication
(10) Pub. No.: US 2012/0275811 A1
(43) Pub. Date: Nov. 1, 2012

(54) COLOR IMAGE FORMING APPARATUS INCLUDING FUNCTION OF CORRECTING COLOR DRIFT OF IMAGE AND COLOR IMAGE FORMING METHOD

(75) Inventor: Hidehito SASAKI, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/415,477

(22) Filed: Mar. 8, 2012

Related U.S. Application Data
(60) Provisional application No. 61/479,349, filed on Apr. 26, 2011.

(51) Int. Cl. G03G 15/01

(52) U.S. Cl. 399/72; 399/301

(57) ABSTRACT

According to one embodiment, a color image forming apparatus includes a pattern forming unit configured to form, if a first pattern for color drift detection may not be able be detected by a detecting unit, a second pattern having a size larger than the size of the first pattern on a transfer belt. The color image forming apparatus further includes a control unit configured to calculate, using a result of detection of the second pattern by the detecting unit, a shift between a detectable position of the detecting unit and a formation position of the first pattern and reform the first pattern.

### CROSS-REFERENCE TO RELATED APPLICATION

This application is based upon and claims the benefit of priority from: U.S. provisional application 61/479,349, filed on Apr. 26, 2011; the entire contents all of which are incorporated herein by reference.

### FIELD

Embodiments described herein relate generally to a color image forming apparatus such as a color copying machine or a color printer that includes a function of correcting superimposition of plural images for respective color components formed on plural photoconductive members.

### BACKGROUND

As the color image forming apparatus, a color image forming apparatus is known that transfers images of colors formed on a photoconductive member by plural image forming stations onto a transfer medium to thereby superimpose the images one on top of another. In such a color image forming apparatus, the images of the colors formed by the plural image forming stations need to be accurately superimposed one on top of another on the transfer medium.

Therefore, in the past, for each of the plural image forming stations, a pattern for color drift detection formed on the transfer medium (e.g., a transfer belt) is detected by a detecting unit and a color drift of the images of the colors is corrected using a correction value obtained on the basis of a result of the detection.

The size of the pattern for color drift detection is determined taking into account, for example, drifts due to various color drift factors (temperature changes and aged deteriorations of components and dimension variations and attachment variations of the components in replacement by maintenance).

However, in this method, since the color drifts due to the various factors are taken into account, the size of the pattern for color drift detection is large. As a result, a large amount of a toner for forming the pattern for color drift detection is consumed.

On the other hand, if the size of the pattern for color drift detection is set too small, for example, even a slight attachment variation of the pattern detecting unit causes a physical shift of a formation position of the pattern for color drift detection with respect to a detectable position of the detecting unit. As a result, since the pattern for color drift detection may be unable to be detected by the pattern detecting unit, color matching correction may not able to be performed.

### DESCRIPTION OF THE DRAWINGS

FIG. 1 is a schematic configuration diagram of a color copying machine in an embodiment;

FIG. 2 is a schematic diagram for explaining a positional relation between a laser exposure device and a photoconductive drum in the embodiment;

FIG. 3 is a schematic diagram for explaining a pattern detecting unit in the embodiment;

FIG. 4 is a block diagram of a control system mainly for color drift correction for an image in the embodiment;

FIG. 5A is a flowchart for explaining formation of a first pattern in the embodiment;

FIG. 5B is a flowchart for explaining formation of a second pattern in the embodiment;

FIG. 6A is a schematic diagram for explaining a form of the first pattern;

FIG. 6B is a schematic diagram for explaining a positional relation among first patterns of all colors;

FIG. 6C is a schematic diagram for explaining form of the second pattern;

FIG. 6D is a schematic diagram for explaining a positional relation among second patterns of all colors;

FIG. 7A is a schematic diagram for explaining a relation between the first pattern and a detection output of a front-side pattern detecting unit in the embodiment;

FIG. 7B is a schematic diagram for explaining a relation between the first pattern and a detection output of a rear-side pattern detecting unit in the embodiment;

FIG. 8A is a schematic diagram for explaining a relation between the second pattern and a detection output of the front-side pattern detecting unit in the embodiment;

FIG. 8B is a schematic diagram for explaining a relation between the second pattern and a detection output of the rear-side pattern detecting unit in the embodiment;

FIG. 9 is a flowchart for explaining color drift correction for an image in the embodiment:

FIG. 10A is a schematic diagram for explaining a relation between a first pattern formation position and a detectable position of the pattern detecting unit in the embodiment;

FIG. 10B is a schematic diagram for explaining a relation between a second pattern formation position and the detectable position of the pattern detecting unit in the embodiment; and

FIG. 10C is a schematic diagram for explaining a relation between the first pattern formation position where the first pattern is reformed and the detectable position of the pattern detecting unit in the embodiment.

### DETAILED DESCRIPTION

In general, according to one embodiment, a color image forming apparatus includes a pattern forming unit configured to form, on a transfer medium, a first pattern for detecting a color drift of images to be superimposed one on top of another or a second pattern different from the first pattern.

The color image forming apparatus further includes a pattern detecting unit configured to detect the first pattern and the second pattern formed by the pattern forming unit.

The color image forming apparatus further includes a control unit configured to control the pattern forming unit to form the first pattern on the transfer medium in order to detect a color drift of the images to be superimposed one on top of another and, if the first pattern is not detected by the pattern detecting unit, form the second pattern on the transfer medium and reform the first pattern using a result of the detection of the second pattern by the pattern detecting unit.

The size of the first pattern is about a size that can be detected by the detecting unit and is a small size with which toner consumption is small, for example, 100 dots×100 dots.

A pair of the detecting units are attached in predetermined positions (hereinafter referred to as reference positions) in two positions (positions on the front side and the rear side of the color image forming apparatus) having a predetermined interval in a direction (a main scanning direction) orthogonal to a moving direction (a sub-scanning direction) of the transfer medium, for example, a transfer belt on which the first pattern is printed. The predetermined positions are, for example, ideal positions determined in product design.

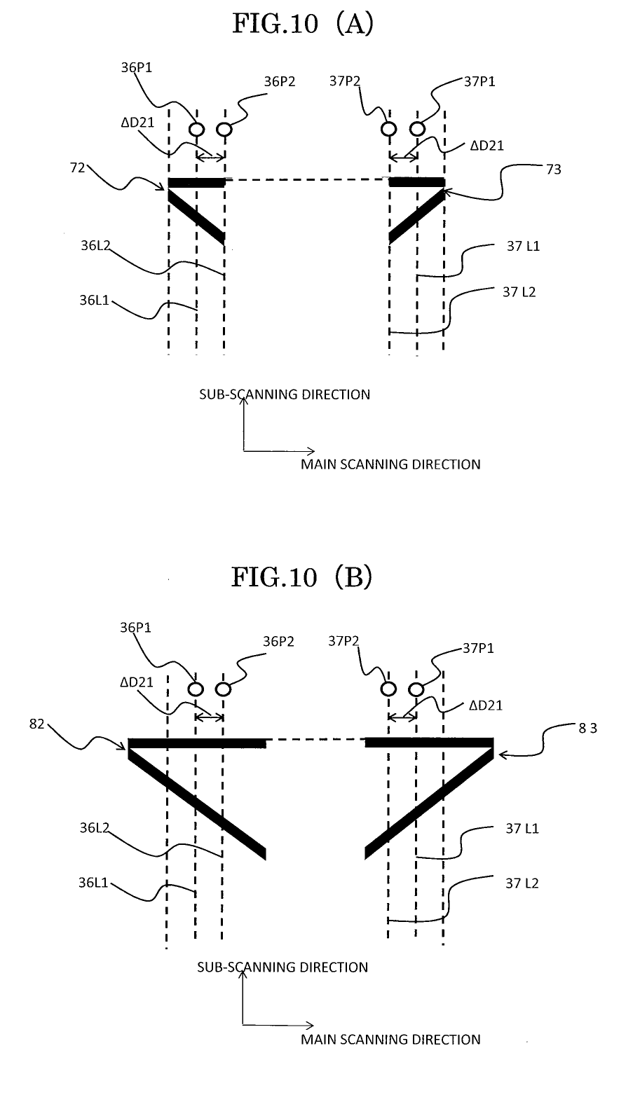

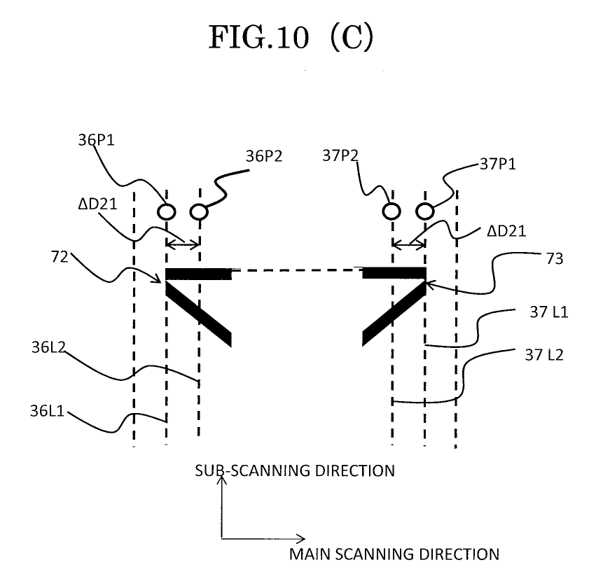

FIGS. 10A to 10C are diagrams for explaining a relation between a detectable position of the detecting unit on the transfer belt and formation positions of the first pattern and the second pattern. First, the pattern forming unit forms first patterns 72 and 73 on the front side and the rear side to correspond to the detecting units on the front side and the rear side. Specifically, as shown in FIG. 10A, the pattern forming unit forms the first pattern 72 on the front side on a detectable line 36L1 that passes a detectable position 36P1 of the detecting unit on the front side and extends along the sub-scanning direction. Further, the pattern forming unit forms the first pattern 73 on the rear side on a detectable line 37L1 that passes a detectable position 37P1 of the detecting unit on the rear side and extends along the sub-scanning direction. The detectable positions 36P1 and 37P1 are detectable positions (ideal detectable positions) set when the pattern detecting units are attached to the reference positions.

The detecting units detect the first patterns 72 and 73 that move on the detectable lines 36L1 and 37L1 according to the movement of the transfer belt and pass the detectable positions 36P1 and 37P1.

For example, actually, if the detecting units are attached to positions different from the reference positions because of an attachment variation, a shift ΔD21 in the main scanning direction occurs between detectable positions (actual detectable positions) 36P2 and 37P2 of the detecting units attached to the different positions and the detectable positions 36P1 and 37P1. In other words, the shift ΔD21 occurs between the actual detectable positions 36P2 and 37P2 and formation positions of the first patterns 72 and 73.

If the shift ΔD21 is small, the first patterns 72 and 73 are located on detectable lines (actual detectable lines) 36L2 and 37L2 that pass the actual detectable positions 36P2 and 37P2 and extend along the sub-scanning direction. Therefore, the detecting units attached to the different positions can detect the first patterns 72 and 73. However, if the shift ΔD21 is large, formation positions of the first patterns 72 and 73 deviate from the actual detectable lines 36L2 and 37L2. In other words, the formation positions of the first patterns 72 and 73 do not pass the actual detectable positions 36P2 and 37P2 even if the first patterns 72 and 73 move according to the movement of the transfer belt. Therefore, the detecting units may be unable to detect the first patterns 72 and 73.

If the detecting units may be unable to detect the first patterns 72 and 73, as shown in FIG. 10B, the pattern forming unit forms the second patterns 82 and 83 for detecting the shift ΔD21 on the ideal detectable lines 36L1 and 37L1 on the transfer belt. The size of the second patterns 82 and 83 is a size with which formation positions of the second patterns 82 and 83 do not deviate from the actual detectable lines 36L2 and 37L2 even if the shift ΔD21 is large to some extent. In other words, the size of the second patterns 82 and 83 is a size with which the detecting units can detect the second patterns 82 and 83 even if the shift ΔD21 is large to some extent and is a size larger than the first patterns 72 and 73, for example, 1000 dots×1000 dots.

The detecting units detect the second patterns 82 and 83. The control unit calculates an amount of the shift ΔD21 using a result of the detection of the second patterns 82 and 83. The control unit controls the pattern forming unit using the calculated amount of the shift ΔD21 as a correction value. As shown in FIG. 10C, the control unit reforms the first patterns 72 and 73 to be located on the actual detectable lines 36L2 and 37L2.

The pattern forming unit includes, for example, image forming stations 11Y, 11M, 11C, and 11K, a laser exposure device 17, and transfer rollers 15Y, 15M, 15C, and 15K explained later. The control unit includes, for example, a CPU 101, an ASIC for laser control 110, and an ASIC for engine control 130.

This embodiment is explained in detail.

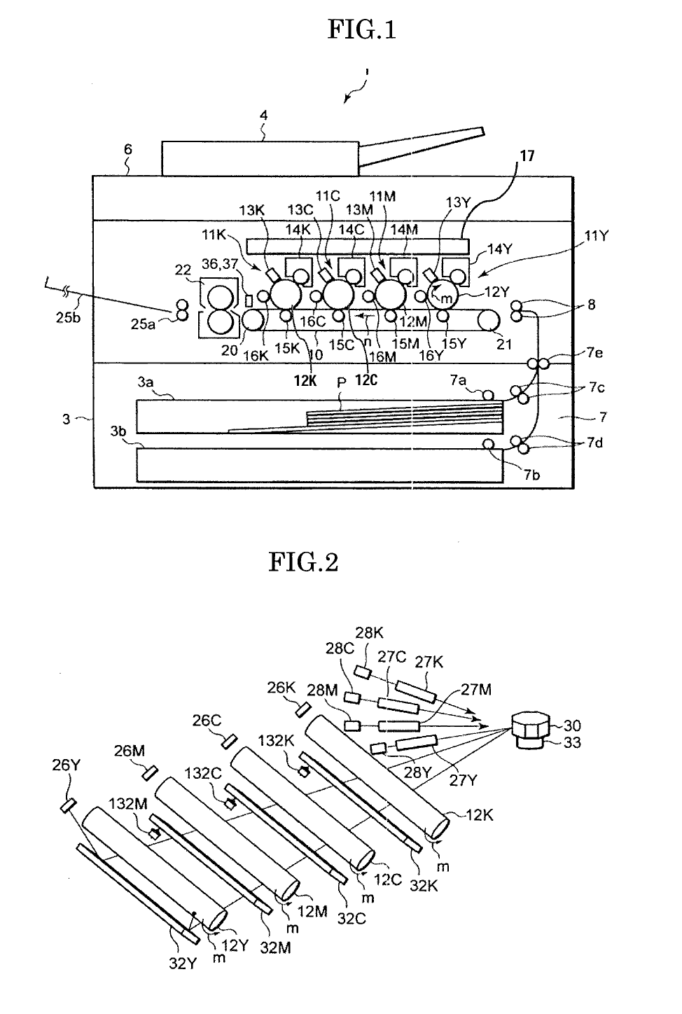

FIG. 1 is a schematic configuration diagram of a color copying machine 1 of a quadruple tandem system, which is the color image forming apparatus according to the embodiment.

The color copying machine 1 includes, in an upper part, a scanner unit 6 that reads an original document fed by an auto document feeder 4. The color copying machine 1 includes image forming stations 11Y, 11M, 11C, and 11K, which are image forming units for four colors of yellow (Y), magenta (M), cyan (C), and black (K) arranged in parallel along a transfer belt 10, which is a transfer medium. The image forming stations 11Y, 11M, 11C, and 11K respectively include photoconductive drums 12Y, 12M, 12C, and 12K. The photoconductive drums 12Y, 12M, 12C, and 12K include rotating shafts parallel to a direction (a main scanning direction) orthogonal to a moving direction (a sub-scanning direction) in an arrow n direction of the transfer belt 10. The rotating shafts of the photoconductive drums 12Y, 12M, 12C, and 12K are arranged to be separated at equal intervals from one another along the sub-scanning direction. Further, the color copying machine 1 includes, around the photoconductive drums 12Y, 12M, 12C, and 12K, electrifying chargers 13Y, 13M, 13C, and 13K, developing devices 14Y, 14M, 14C, and 14K, and photoconductive member cleaners 16Y, 16M, 16C, and 16K arranged along a rotating direction in an arrow m direction of the photoconductive drums 12Y, 12M, 12C, and 12K.

The electrifying charges 13Y, 13M, 13C, and 13K uniformly charge the photoconductive drums 12Y, 12M, 12C, and 12K to predetermined potential.

The developing devices 14Y, 14M, 14C, and 14K respectively include, as color materials, developers including toners of Y, M, C, and K. The developing devices 14Y, 14M, 14C, and 14K supply the toners to electrostatic latent images formed on the photoconductive drums 12Y, 12M, 12C, and 12K and form toner images.

Further, the color copying machine 1 includes the laser exposure device 17. The laser exposure device 17 irradiates a laser beam in positions between the electrifying chargers 13Y, 13M, 13C, and 13K and the developing devices 14Y, 14M, 14C, and 14K around the photoconductive drums 12Y, 12M, 12C, and 12K to thereby expose the photoconductive drums 12Y, 12M, 12C, and 12K to the laser beam and form the electrostatic latent images on the photoconductive drums 12Y, 12M, 12C, and 12K.

For example, as shown in FIG. 2, the laser exposure device 17 includes laser oscillators 27Y, 27M, 27C, and 27K and laser drivers 28Y, 28M, 28C, and 28K. The laser oscillators 27Y, 27M, 27C, and 27K respectively output laser beams, which are exposure beams, to the photoconductive drums 12Y, 12M, 12C, and 12K. The laser drivers 28Y, 28M, 28C, and 28K control the laser oscillators 27Y, 27M, 27C, and 27K on the basis of data for respective color (Y, M, C, and K) components of image data read by the scanner unit 6. When color drift detection explained later is performed, the laser drivers 28Y, 28M, 28C, and 28K control the laser oscillators 27Y, 27M, 27C, and 27K on the basis of first pattern data equivalent to the first pattern and second pattern data equivalent to the second pattern.

The laser exposure device 17 further includes a polygon mirror 30 and tilt mirrors 32Y, 32M, 32C, and 32K. The polygon mirror 30 is rotated by a polygon mirror motor 33. The polygon mirror 30 reflects the laser beams from the laser oscillators 27Y, 27M, 27C, and 27K while rotating and scans the photoconductive drums 12Y, 12M, 12C, and 12K in the main scanning direction using the laser beams. The tilt mirrors 32Y, 32M, 32C, and 32K adjust incident angles of the laser beams reflected by the polygon mirror 30 on the photoconductive drums 12Y, 12M, 12C, and 12K. Attachment angles of the tilt mirrors 32Y, 32M, 32C, and 32K can be changed by tilt mirror motors 132M, 132C, and 132K. The attachment angles of the tilt mirrors 32Y, 32M, 32C, and 32K are changed, whereby the rotating shafts of the photoconductive drums 12Y, 12M, 12C, and 12K (the main scanning direction) and the scanning direction of the laser beams can be adjusted to parallel. For example, the attachment angles are changed on the basis of a correction value of a color drift amount due to a skew explained later, whereby a color drift can be corrected.

The laser exposure device 17 includes horizontal synchronization signal detection sensors 26Y, 26M, 26C, and 26K that are provided on extended lines in the main scanning direction of the photoconductive drums 12Y, 12M, 12C, and 12K and detect the laser beams and output horizontal synchronization signals. The laser exposure device 17 determines scanning start positions in the main scanning direction on the photoconductive drums 12Y, 12M, 12C, and 12K on the basis of the horizontal synchronization signals. The scanning start positions on the photoconductive drums 12Y, 12M, 12C, and 12K are changed on the basis of a correction value of a color drift amount in the main scanning direction explained later, whereby a color drift can be corrected.

The transfer belt 10 is supported by a driving roller 20 and a driven roller 21 and moves (endlessly travels) in the arrow n direction according to driving of the driving roller 20 by a belt motor 10a. The toner images of the colors (Y, M, C, and K) formed on the photoconductive drums 12Y, 12M, 12C, and 12K are transferred onto sheet paper P, which is conveyed in the arrow n direction by the transfer belt 10, one on top of another by the transfer rollers 15Y, 15M, 15C, and 15K. Consequently, a color toner image is formed on the sheet paper P conveyed by the transfer belt 10.

The color copying machine 1 includes a cassette mechanism 3 including first and second paper feeding cassettes 3a and 3b that store the sheet paper P. The cassette mechanism 3 feeds the sheet paper P to the transfer belt 10 through a conveying unit 7. The conveying unit 7 includes pickup rollers 7a and 7b that pick up the sheet paper P from the paper feeding cassettes 3a and 3b, separating and conveying rollers 7c and 7d, a conveying roller 7e, and a registration roller 8.

Further, the color copying machine 1 includes a fixing device 22 and a paper discharge section (a paper discharge roller 25a and a paper discharge tray 25b). The fixing device 22 fixes the color toner image formed on the sheet paper P after the end of the transfer. Consequently, printing of a color image on the sheet paper P is completed. The paper discharge roller 25a discharges the sheet paper P having the color image formed thereon to the paper discharge tray 25b.

After the end of the transfer, the photoconductive member cleaners 16Y, 16M, 16C, and 16K remove residual toners from the photoconductive drums 12Y, 12M, 12C, and 12K and changes the photoconductive drums 12Y, 12M, 12C, and 12K to a state in which the next printing can be performed.

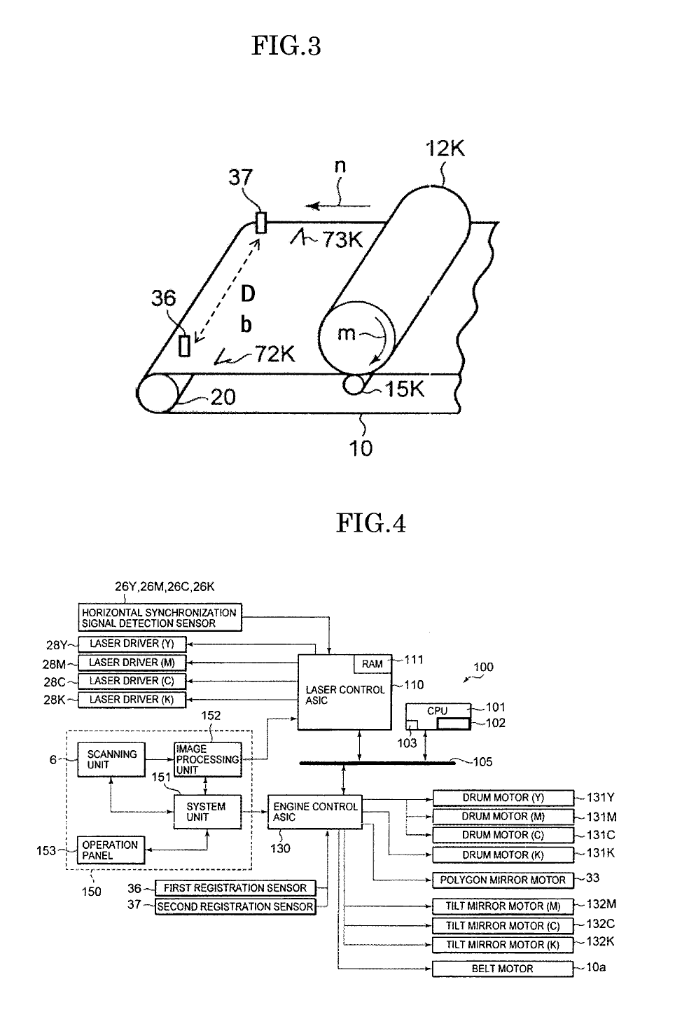

As shown in FIG. 3, the color copying machine 1 includes, downstream of the image forming station 11K for K on the transfer belt 10, a pair of a first registration sensor 36 and a second registration sensor 37, which are the pattern detecting units. The registration sensors 36 and 37 are attached a predetermined interval Db apart from each other in the main scanning direction. The registration sensor 36 is attached, for example, on the front side of the color copying machine 1. The registration sensor 37 is provided, for example, on the rear side of the color copying machine 1. Attachment positions of the registration sensors 36 and 37 are positions determined in advance in design (the reference positions).

In the configuration of the color copying machine 1 explained above, the image forming station 11Y for Y is designed in a structure in which a color drift is least easily occurs. Therefore, Y is adopted as a reference color in calculating various color drift amounts explained later.

A control system that controls color drift correction for an image is explained. FIG. 4 is a block diagram of a control unit 100 that mainly performs correction of a color drift of an image.

The control unit 100 includes a CPU (Central Processing Unit) 101, which is a processing control unit, an ASIC (Application Specific Integrated Circuit) for laser control 110, which is a correcting unit, and an ASIC for engine control 130.

The CPU (Central Processing Unit) 101 is connected to the ASIC for laser control 110 and the ASIC for engine control 130 via an input and output interface 105 and controls the entire color copying machine 1. The CPU 101 includes a memory 102 that stores various kinds of setting for controlling the ASIC for laser control 110 and the ASIC for engine control 130 and a calculating unit 103 that calculates a correction value for correction for a color drift of the image and correction of the shift ΔD21 (a shift of pattern formation positions with respect to the detectable positions of the sensors 36 and 37).

The ASIC for laser control 110 includes a RAM 111 that stores various kinds of setting for controlling the laser drivers 28Y, 28M, 28C, and 28K. The horizontal synchronization signal detection sensors 26Y, 26M, 26C, and 26K are connected to the ASIC for laser control 110.

Drum motors 131Y, 131M, 131C, and 131K that drive the photoconductive drums 12Y, 12M, 12C, and 12K, the polygon mirror motor 33 that drives the polygon mirror 30, the belt motor 10a that drives the transfer belt 10, the tilt mirror motors 132M, 132C, and 132K that drive the tilt mirrors 32M, 32C, and 32K, and the first and second registration sensors 36 and 37 are connected to the ASIC for engine control 130.

A print control unit 150 for carrying out image formation in the color copying machine 1 is connected to the ASIC for laser control 110 and the ASIC for engine control 130. The print control unit 150 includes a system unit 151, an image processing unit 152, an operation panel 153, and the scanner unit 6.

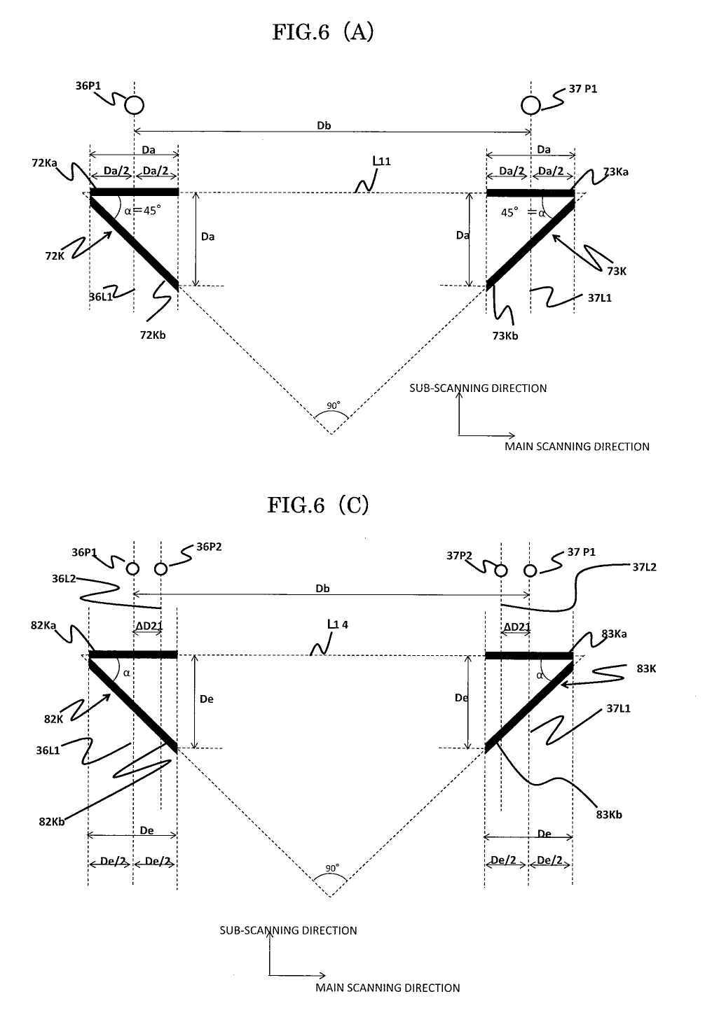

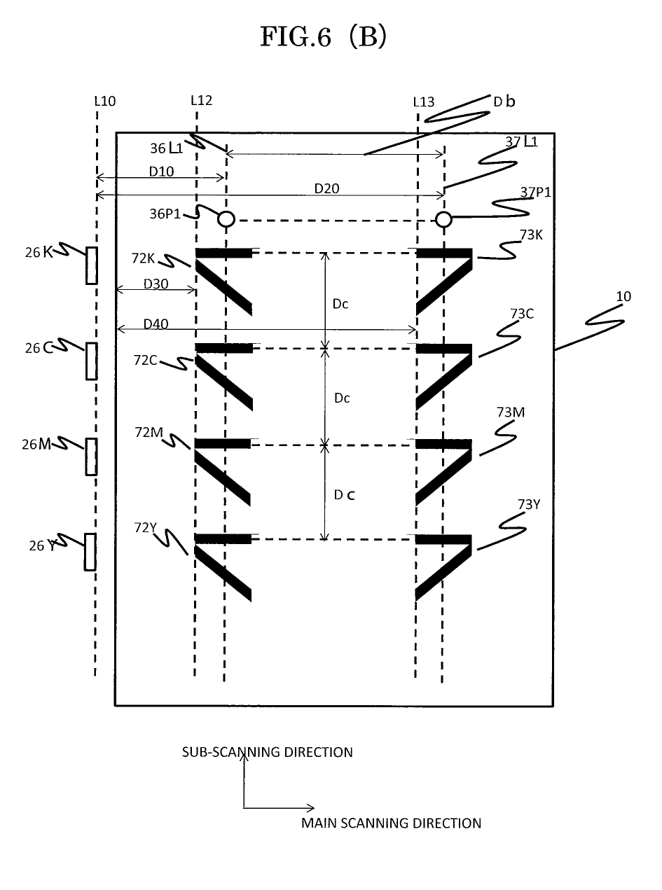

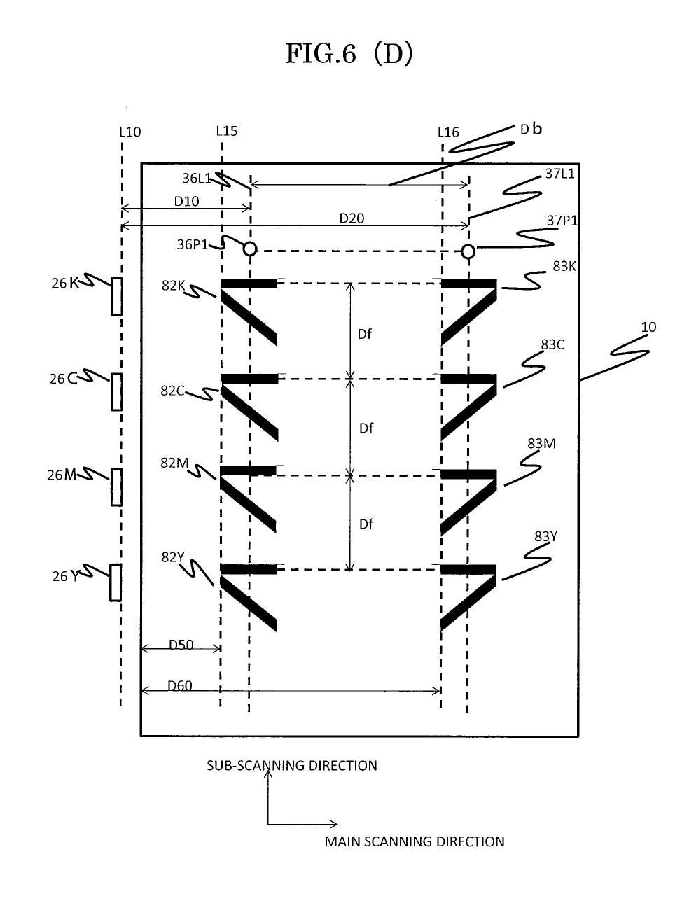

The first patterns 72 and 73 for detecting a color drift of an image are explained with reference to FIGS. 6A to 6D.

The first patterns 72 and 73 are formed on the transfer belt 10 for each of the colors Y, M, C, and K. First patterns 72K, 72C, 72M, and 72Y and 73K, 73C, 73M, and 73Y of the colors have the same form. Therefore, the first patterns 72K and 73K of K are representatively explained with reference to FIG. 6A. Pattern formation positions shown in FIG. 6A indicate that the sensors 36 and 37 are attached to the reference positions (the positions predetermined in design) and various color drifts do not occur.

In FIG. 6A, a first pattern of K includes the first pattern 72K printed on the front side and the first pattern 73K printed on the rear side. The first pattern 72K has a wedge shape formed by a first linear portion 72Ka and a second linear portion 72Kb. An angle α of a vertex where one end (a front side end) of the linear portion 72Ka and one end (a front side end) of the linear portion 72Kb cross each other is 45°. The linear portion 72Ka is parallel to the main scanning direction. When the length of the linear portion 72Ka is represented as Da, length between the other end (the rear side) of the linear portion 72Ka and the other end (the rear side) of the linear portion 72Kb is also Da.

Similarly, the first pattern 73K has a wedge shape formed by a first linear portion 73Ka and a second linear portion 73Kb. An angle α of a vertex where one end (a rear side end) of the linear portion 73Ka and one end (a rear side end) of the linear portion 73Kb cross is 45°. The linear portion 73Ka is parallel to the main scanning direction. When the length of the linear portion 73Ka is represented as Da (equal to the length Da of the linear portion 72Ka), length between the other end (a front side end) of the linear portion 73Ka and the other end (a front side end) of the linear portion 73Kb is also Da.

In the first patterns 72K and 73K, the linear portions 72Ka and 73Ka are formed on the same line L11 parallel to the main scanning direction. Further, the first pattern 72K is formed in a position where the center of the first pattern 72K is on the ideal detectable line 36L1 of the first registration sensor 36 (a position where the ideal detectable line 36L1 passes the center of the linear portion 72Ka). The first pattern 73K is formed in a position where the center of the first pattern 73K is on the ideal detectable line 37L1 of the second registration sensor 37 (a position where the ideal detectable line 37L1 passes the center of the linear portion 73Ka). In other words, as shown in FIG. 6A, the first patterns 72K and 73K are formed bilaterally symmetrically while having a predetermined interval Db in the main scanning direction (an interval between the center of the linear portion 72Ka and the center of the linear portion 73Ka).

The first patterns 72C, 72M, and 72Y of C, M, and Y on the front side and the first patterns 73C, 73M, and 73Y of C, M, and Y on the rear side are also formed on the transfer belt 10 while having the same form as the first patterns 72K and 73K.

FIG. 6B is a diagram for explaining a positional relation among first patterns of the colors including the first patterns 72K, 72C, 72M, and 72Y of the colors on the front side and the first patterns 73K, 73C, 73M, and 73Y on the rear side formed on the transfer belt 10. In FIG. 6B, pattern formation positions indicate that the sensors 36 and 37 are attached to the reference positions (the positions predetermined in design) and various color drifts do not occur. The first patterns 72K, 72C, 72M, and 72Y and 73K, 73C, 73M, and 73Y of the colors are formed respectively while having a predetermined interval Dc in the sub-scanning direction (an interval set when there is no color drift in the sub-scanning direction).

The second patterns 82 and 83 for detecting the shift ΔD21 are explained with reference to FIGS. 6C and 6D.

The second patterns 82 and 83 are also formed on the transfer belt 10 for each of the colors Y, M, C, and K. Since the second patterns 82K, 82C, 82M, and 82Y and 83K, 83C, 83M, and 83Y of the colors have the same form, first, the second patterns 82K and 83K are representatively explained with reference to FIG. 6C.

The second patterns 82 and 83 have a size larger than the size of the first patterns 72 and 73. The size of the second patterns 82 and 83 is determined as a size that can be detected even if the detectable positions shift because the attachment positions of the registration sensors 36 and 37 shift from the reference positions (the positions predetermined in design) (even if the detectable positions shift from the ideal detectable positions 36P1 and 37P1 to the actual detectable positions 36P2 and 37P2). For example, as explained above, if the size of the first pattern is 100 dots×100 dot, the size of the second pattern is 1000 dots×1000 dots. The form of the second patterns is the same as the form of the first patterns except the size.

In FIG. 6C, the second pattern of K includes the second pattern 82K formed on the front side and the second pattern 83K formed on the rear side. The second pattern 82K has a wedge shape formed by a first linear portion 82Ka and a second linear portion 82Kb. An angle α of a vertex where one end (a front side end) of the linear portion 82Ka and one end (a front side end) of the linear portion 82Kb cross each other is 45°. The linear portion 82Ka is parallel to the main scanning direction. When the length of the linear portion 82Ka is represented as De (=Da×10), length between the other end (the rear side end) of the linear portion 82Ka and the other end (the rear side end) of the linear portion 82Kb is also De.

Similarly, the second pattern 83K has a wedge shape formed by a first linear portion 83Ka and a second linear portion 83Kb. An angle α of a vertex where one end (a rear side end) of the linear portion 83Ka and one end (a rear side end) of the linear portion 83Kb cross is 45°. The linear portion 83Ka is parallel to the main scanning direction. When the length of the linear portion 83Ka is represented as De (equal to the length De of the linear portion 82Ka), length between the other end (a front side end) of the linear portion 83Ka and the other end (a front side end) of the linear portion 83Kb is also De.

In the second patterns 82K and 83K, the linear portions 82Ka and 83Ka are formed on the same line L14 parallel to the main scanning direction. Further, like the first pattern, the second pattern 82K is formed in a position where the center of the second pattern 82K is on the ideal detectable line 36L1 of the first registration sensor 36 (a position where the ideal detectable line 36L1 passes the center of the linear portion 82Ka). At this point, as explained above, since the size of the second pattern 82K is larger than the size of the first pattern 72, even if an amount of ΔD21 is large, the second pattern 82K is located on the actual detectable line 36L2 (the line in the sub-scanning direction that passes the actual detectable position 36P2).

Like the first pattern 73, the second pattern 83K is formed in a position where the center of the second pattern 83K is on the ideal detectable line 37L1 of the second registration sensor 37 (a position where the ideal detectable line 37L1 passes the center of the linear portion 83Ka). At this point, as explained above, since the size of the second pattern 83K is larger than the size of the first pattern 73, even if an amount of ΔD21 is large, the second pattern 83K is located on the actual detectable line 37L2 (the line in the sub-scanning direction that passes the actual detectable position 37P2).

As shown in FIG. 6C, the second patterns 82K and 83K are formed bilaterally symmetrically while having the predetermined interval Db in the main scanning direction (an interval between the center of the linear portion 82Ka and the center of the linear portion 83Ka).

The second patterns 82C, 82M, and 82Y of C, M, and Y on the front side and the second patterns 83C, 83M, and 83Y of C, M, and Y on the rear side are also formed on the transfer belt 10 while having the same form as the second patterns 82K and 83K of K.

FIG. 6D is a diagram for explaining a positional relation among first patterns of the colors formed when the second patterns 82K, 82C, 82M, and 82Y of the colors on the front side and the second patterns 83K, 83C, 83M, and 83Y on the rear side are formed on the transfer belt 10. The second patterns 82K, 82C, 82M, and 82Y and 83K, 83C, 83M, and 83Y of the colors are formed respectively while having a predetermined interval Df in the sub-scanning direction (an interval set when there is no color drift in the sub-scanning direction).

Pattern formation data for forming the first pattern and the second pattern explained above is stored in the memory 102 of the CPU 1. The pattern formation data includes first pattern formation data and second pattern formation data. The first pattern formation data includes first pattern data equivalent to the first patterns 72Y, 72M, 72C, and 72K on the front side and the first patterns 73Y, 73M, 73C, and 73K on the rear side. Further, the first pattern formation data includes data concerning start positions where electrostatic latent images equivalent to the first patterns 72Y, 72M, 72C, and 72K on the front side and the first patterns 73Y, 73M, 73C, and 73K on the rear side are formed on the photoconductive drums 12Y, 12M, 12C, and 12K (positions corresponding to the start positions where the first patterns 72Y, 72M, 72C, and 72K and the first patterns 73Y, 73M, 73C, and 73K are formed on the transfer belt 10).

The second pattern formation data includes second pattern data equivalent to the second patterns 82Y, 82M, 82C, and 82K on the front side and the second patterns 83Y, 83M, 83C, and 83K on the rear side. Further, the second pattern formation data includes data concerning start positions where electrostatic latent images equivalent to the second patterns 82Y, 82M, 82C, and 82K on the front side and the second patterns 83Y, 83M, 83C, and 83K on the rear side are formed on the photoconductive drums 12Y, 12M, 12C, and 12K (positions corresponding to the start positions where the second patterns 82Y, 82M, 82C, and 82K and the second patterns 83Y, 83M, 83C, and 83K are formed on the transfer belt 10).

The data concerning the start positions where the first and second patterns are formed is for example, a target count value of a reference clock signal counted after reception of the horizontal synchronization signals by the horizontal synchronization signal detection sensors 26Y, 26M, 26C, and 26K.

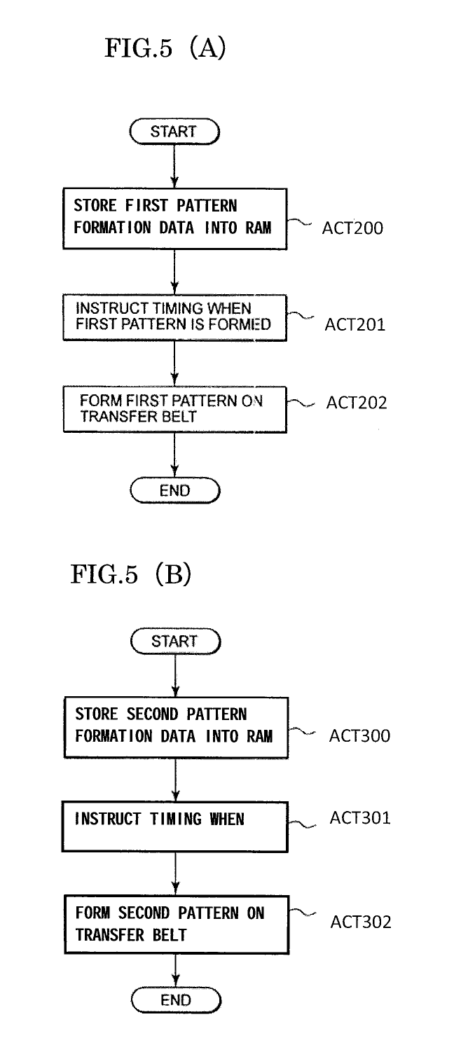

Processing for forming the first pattern on the transfer belt 10 is explained with reference to a flowchart of FIG. 5A.

When the first pattern is formed on the transfer belt 10, paper feeding from the cassette mechanism 3 is not performed. Otherwise, the color copying machine 1 operates as in the normal image forming process. Therefore, the first patterns 72Y, 72M, 72C, and 72K on the front side and the first patterns 73Y, 73M, 73C, and 73K on the rear side formed on the photoconductive drums 12Y, 12M, 12C, and 12K are directly transferred onto the transfer belt 10 that is caused to travel at predetermined speed.

When the first pattern is formed, first, the CPU 101 reads out, from the memory 102, the first pattern formation data for forming the first patterns 72Y, 72M, 72C, and 72K on the front side and the first patterns 73Y, 73M, 73C, and 73K on the rear side. The ASIC for laser control 110 stores the first pattern formation data in the RAM 111 (ACT 200).

Subsequently, the ASIC for laser control 110 instructs, according to the first pattern formation data stored in the RAM 111, the laser drives 28Y, 28M, 28C, and 28K about start timing for forming an electrostatic latent image corresponding to the first pattern on the photoconductive drum (ACT 201).

Specifically, on the transfer belt 10, positions P26Y, P26M, P26C, and P26K (positions on a line L10 in the sub-scanning direction) equivalent to the horizontal synchronization signal detection sensors 26Y, 26M, 26C, and 26K are set as references (see FIG. 6B). The detectable position 36P1 of the registration sensor 36 is present in a position of a predetermined count value n1 of the reference clock signal from the reference positions P26Y, P26M, P26C, and P26K. The detectable position 37P1 of the registration sensor 37 is present in a position of a predetermined count value n2 (n1<n2) from the reference positions P26Y, P26M, P26C, and P26K.

In other words, as shown in FIG. 6B, on the transfer belt 10, the position of the count value n1 from the reference positions P26Y, P26M, P26C, and P26K is equivalent to a distance of D10 from the reference positions P26Y, P26M, P26C, and P26K. The position of the count value n2 from the reference positions P26Y, P26M, P26C, and P26K is equivalent to a distance of D20 from the reference positions P26Y, P26M, P26C, and P26K.

When the first pattern is formed, after receiving the horizontal synchronization signals from the horizontal synchronization signal detection sensors 26Y, 26M, 26C, and 26K, the ASIC for laser control 110 counts the reference clock signal and instructs the laser drivers 28Y, 28M, 28C, and 28K to start formation of electrostatic latent images corresponding to the first patterns 72K, 72C, 72M, and 72Y on the front side using the first pattern data from an m1th count (m1<n1), which is a target count value (a count value equivalent to a distance D30 from the reference positions P26Y, P26M, P26C, and P26K to a pattern formation start position).

Further, after receiving the horizontal synchronization signals, the ASIC for laser control 110 counts the reference clock signal and instructs the laser drivers 28Y, 28M, 28C, and 28K to start formation of electrostatic latent images corresponding to the first patterns on the rear side using the first pattern data from an m2th count (n1<m2<n2), which is the next target count value (a count value equivalent to a distance D40 from the reference positions P26Y, P26M, P26C, and P26K to the pattern formation start position).

Consequently, on the photoconductive drums 12Y, 12M, 12C, and 12K, the formation of the electrostatic latent images of the first patterns 72Y, 72M, 72C, and 72K on the front side based on the first pattern data is started from a position equivalent to a first pattern formation start position on the front side (a position on a line L12 in the sub-scanning direction) shown in FIG. 6B. The formation of the electrostatic latent images of the first patterns 73Y, 73M, 73C, and 73K on the rear side based on the first pattern data is started from a position equivalent to a first pattern formation start position on the rear side (a position on a line L13 in the sub-scanning direction). Subsequently, the developing devices 14Y, 14M, 14C, and 14K form toner images of the first patterns 72Y, 72M, 72C, and 72K and 73Y, 73M, 73C, and 73K on the photoconductive drums 12Y, 12M, 12C, and 12K. Thereafter, the transfer rollers 15Y, 15M, 15C, and 15K transfer the toner images of the first patterns onto the transfer belt 10.

Consequently, as shown in FIG. 6B, the first patterns 72Y, 72M, 72C, and 72K and 73Y, 73M, 73C, and 73K are formed centering around the ideal detectable lines 36L1 and 37L2 (ACT 202) on the transfer belt 10.

In the above explanation, the first patterns 72 and 73 are formed centering around the ideal detectable lines 36L1 and 37L1 on the transfer belt 10. On the other hand, if the sensors 36 and 37 may be unable to detect the first patterns 72 and 73 formed as explained above because the sensors 36 and 37 are attached to positions deviating from predetermine positions, using an amount of a shift ΔD21 explained later as a correction amount, as shown in FIG. 10C, the first patterns 72 and 73 are formed centering around the actual detectable lines 36L2 and 37L2 on the transfer belt 10. Specifically, in this case, in ACT 201, using a count value obtained by correcting the count values m1 and m2 taking into account the amount of the shift ΔD21 as the target count value instead of the target count values m1 and m2 of the reference clock signal, the first patterns 72 and 73 are formed centering around the actual detectable lines 36L2 and 37L2.

Processing for forming the second pattern on the transfer belt 10 is explained with reference to a flowchart of FIG. 5B. When the second pattern is formed on the transfer belt 10, as in the formation of the first pattern explained above, paper feeding from the cassette mechanism 3 is not performed. Otherwise, the color copying machine 1 operates as in the normal image forming process. Therefore, the second patterns 82Y, 82M, 82C, and 82K on the front side and the second patterns 83Y, 83M, 83C, and 83K on the rear side formed on the photoconductive drums 12Y, 12M, 12C, and 12K are directly transferred onto the transfer belt 10 that moves at the predetermined speed.

When the second pattern is formed, first, the CPU 101 reads out, from the memory 102, the second pattern formation data for forming the first patterns 82Y, 82M, 82C, and 82K on the front side and the first patterns 83Y, 83M, 83C, and 83K on the rear side. The ASIC for laser control 110 stores the second pattern formation data in the RAM 111 (ACT 300).

Subsequently, the ASIC for laser control 110 instructs, according to the second pattern formation data stored in the RAM 111, the laser drives 28Y, 28M, 28C, and 28K about start timing for forming an electrostatic latent image corresponding to the second pattern on the photoconductive drum (ACT 301).

Specifically, as in the formation of the first pattern, on the transfer belt 10, the positions P26Y, P26M, P26C, and P26K (the positions on the line L10 in the sub-scanning direction) equivalent to the horizontal synchronization signal detection sensors 26Y, 26M, 26C, and 26K are set as references (see FIG. 6D). The detectable position 36P1 of the registration sensor 36 is present in the position of the predetermined count value n1 of the reference clock signal from the reference positions P26Y, P26M, P26C, and P26K. The detectable position 37P1 of the registration sensor 37 is present in the position of the predetermined count value n2 (n1<n2) from the reference positions P26Y, P26M, P26C, and P26K. In other words, as shown in FIG. 6D, on the transfer belt 10, the position of the count value n1 from the reference positions P26Y, P26M, P26C, and P26K is equivalent to the distance of D10 from the reference positions P26Y, P26M, P26C, and P26K. The position of the count value n2 from the reference positions P26Y, P26M, P26C, and P26K is equivalent to the distance of D20 from the reference positions P26Y, P26M, P26C, and P26K.

When the second pattern is formed, as in the formation of the first pattern, after receiving the horizontal synchronization signals from the horizontal synchronization signal detection sensors 26Y, 26M, 26C, and 26K, the ASIC for laser control 110 counts the reference clock signal and instructs the laser drivers 28Y, 28M, 28C, and 28K to start formation of electrostatic latent images corresponding to the second patterns 82K, 82C, 82M, and 82Y on the front side using the second pattern data from an m3th count (m3<n1), which is a target count value (a count value equivalent to a distance D50 from the reference positions P26Y, P26M, P26C, and P26K to a pattern formation start position).

Further, after receiving the horizontal synchronization signals, the ASIC for laser control 110 counts the reference clock signal and instructs the laser drivers 28Y, 28M, 28C, and 28K to start formation of electrostatic latent images corresponding to the second patterns 83K, 83C, 83M, and 83K on the rear side using the second pattern data from an m4th count (n1<m4<n2), which is the next target count value (a count value equivalent to a distance D60 from the reference positions P26Y, P26M, P26C, and P26K to the pattern formation start position).

Consequently, on the photoconductive drums 12Y, 12M, 12C, and 12K, the formation of the electrostatic latent images of the second patterns 82Y, 82M, 82C, and 82K on the front side based on the second pattern data is started from a position equivalent to a second pattern formation start position on the front side (a position on a line L15 in the sub-scanning direction) shown in FIG. 6D. The formation of the electrostatic latent images of the second patterns 83Y, 83M, 83C, and 83K on the rear side based on the second pattern data is started from a position equivalent to a second pattern formation start position on the rear side (a position on a line L16 in the sub-scanning direction). Subsequently, the developing devices 14Y, 14M, 14C, and 14K form toner images of the second patterns 82Y, 82M, 82C, and 82K and 83Y, 83M, 83C, and 83K on the photoconductive drums 12Y, 12M, 12C, and 12K. Thereafter, the transfer rollers 15Y, 15M, 15C, and 15K transfer the toner images onto the transfer belt 10. Consequently, as shown in FIG. 6D, the second patterns 82Y, 82M, 82C, and 82K and 83Y, 83M, 83C, and 83K are formed centering around the ideal detectable lines 36L1 and 37L1 (ACT 302).

A method of detecting the first patterns 72K, 72C, 72M, and 72Y and 73K, 73C, 73M, and 73Y and the second patterns 82K, 82C, 82M, and 82Y and 83K, 83C, 83M, and 83Y by the first registration sensor 36 and the second registration sensor 37 is explained.

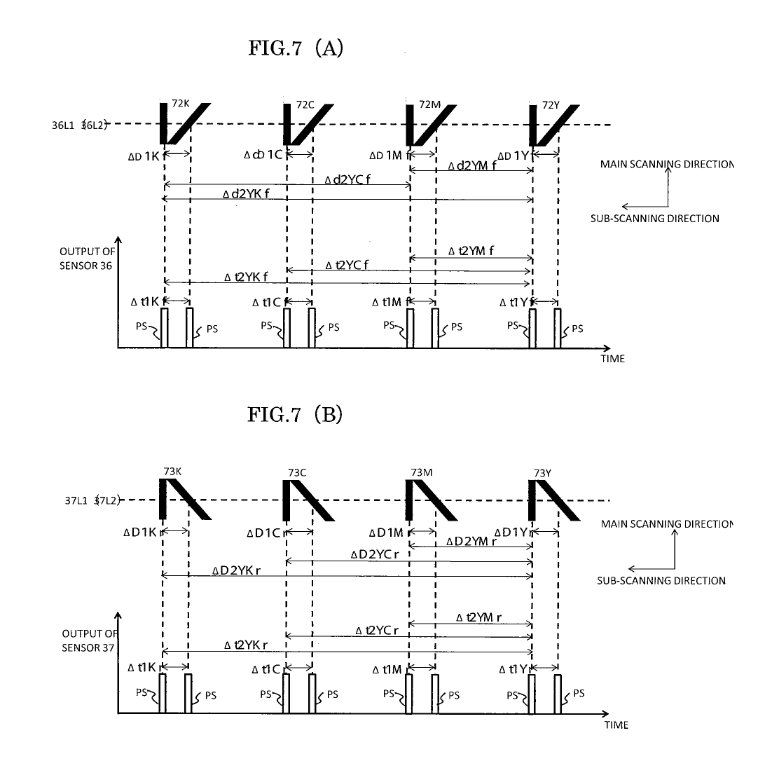

FIG. 7A is a diagram of an output of the first registration sensor 36 that detects the first patterns 72K, 72C, 72M, and 72Y formed as explained above. FIG. 7B is a diagram of an output of the second registration sensor 37 that detects the first patterns 73K, 73C, 73M, and 73Y formed as explained above.

The first registration sensor 36 and the second registration sensor 37 output a pulse signal PS every time the sensors detect first linear portions 72Ka, 72Ca, 72Ma, and 72Ya and 73Ka, 73Ca, 73Ma, and 73Ya and second linear portions 72Kb, 72Cb, 72Mb, and 72Yb and 73Kb, 73Cb, 73Mb, and 73Yb of the first patterns 72K, 72C, 72M, and 72Y and 73K, 73C, 73M, and 73Y. Specifically, the first patterns 72K, 72C, 72M, and 72Y and 73K, 73C, 73M, and 73Y formed on the transfer belt 10 move on the detectable lines 36L1 and 37L1 according to the movement of the transfer belt 10. First, the first linear portions 72Ka, 72Ca, 72Ma, and 72Ya and 73Ka, 73Ca, 73Ma, and 73Ya of the first patterns pass the detectable positions 36P1 and 37P1 of the first registration sensor 36 and the second registration sensor 37. When the first linear portions 72Ka, 72Ca, 72Ma, and 72Ya and 73Ka, 73Ca, 73Ma, and 73Ya pass the detectable positions 36P1 and 37P1, the first registration sensor 36 and the second registration sensor 37 detect the first linear portions 72Ka, 72Ca, 72Ma, and 72Ya and 73Ka, 73Ca, 73Ma, and 73Ya and output the pulse signal PS. Subsequently, the second linear portions 72Kb, 72Cb, 72Mb, and 72Yb and 73Kb, 73Cb, 73Mb, and 73Yb of the first patterns 72K, 72C, 72M, and 72Y and 73K, 73M, 73C, and 73Y pass the detectable positions 36P1 and 37P2 of the first registration sensor 36 and the second registration sensor 37. When the second linear portions 72Kb, 72Cb, 72Mb, and 72Yb and 73Kb, 73Cb, 73Mb, and 73Yb pass the detectable positions 36P1 and 37P1, the first registration sensor 36 and the second registration sensor 37 detect the second linear portions 72Kb, 72Cb, 72Mb, and 72Yb and 73Kb, 73Cb, 73Mb, and 73Yb and output the pulse signal PS.

In the case of the reformed first patterns 72K, 72C, 72M, and 72Y and 73K, 73C, 73M, and 73Y, the first patterns 72K, 72C, 72M, and 72Y and 73K, 73C, 73M, and 73Y move on the detectable lines 36L2 and 37L2 according to the movement of the transfer belt 10 and pass the detectable positions 36P2 and 37P2 of the first registration sensor 36 and the second registration sensor 37. As explained above, the first registration sensor 36 and the second registration sensor 37 output the pulse signal PS every time the sensors detect the first linear portions 72Ka, 72Ca, 72Ma, and 72Ya and 73Ka, 73Ca, 73Ma, and 73Ya and the second linear portions 72Kb, 72Cb, 72Mb, and 72Yb and 73Kb, 73Cb, 73Mb, and 73Yb of the first patterns 72K, 72C, 72M, and 72Y and 73K, 73C, 73M, and 73Y.

The method of detecting the first patterns 72 and 73 with the first registration sensor 36 and the second registration sensor 37 is explained above. A method of detecting the second patterns 82K, 82C, 82M, and 82Y and 83K, 83C, 83M, and 83Y with the first registration sensor 36 and the second registration sensor 37 is the same as the method of detecting the first patterns.

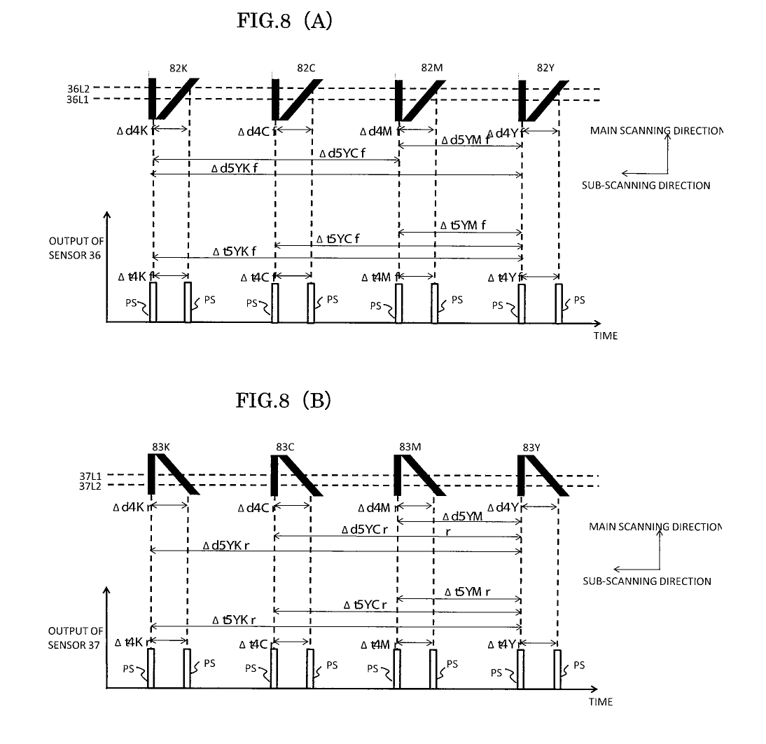

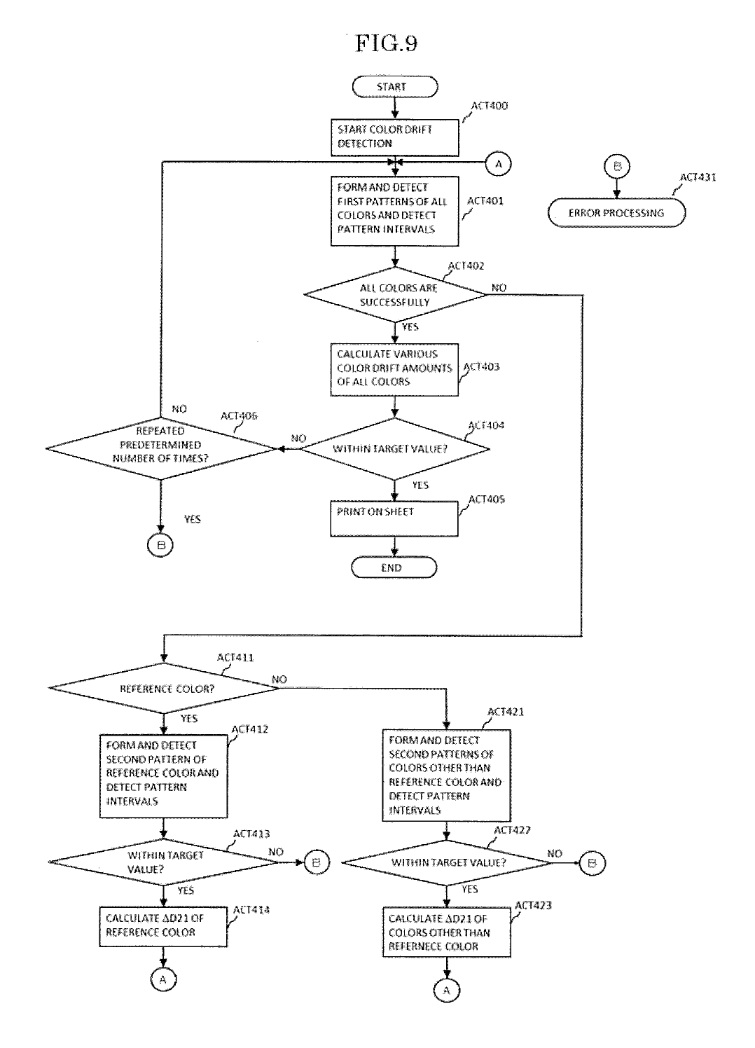

Specifically, as shown in FIGS. 8A and 8B, the first registration sensor 36 and the second registration sensor 37 output the pulse signal PS every time the sensors detect first linear portions 82Ka, 82Ca, 82Ma, and 82Ya and 83Ka, 83Ca, 83Ma, and 83Ya and second linear portions 82Kb, 82Cb, 82Mb, and 82Yb and 83Kb, 83Cb, 83Mb, and 83Yb of the second patterns 82K, 82C, 82M, and 82Y and 83K, 83C, 83M, and 83Y. However, in this case, the second patterns 82K, 82C, 82M, and 82Y and 83K, 83C, 83M, and 83Y formed on the transfer belt 10 move on not only the detectable lines 36L1 and 37L1 but also the detectable lines 36L2 and 37L2 according to the movement of the transfer belt 10. Therefore, the first linear portions 82Ka, 82Ca, 82Ma, and 82Ya and 83Ka, 83Ca, 83Ma, and 83Ya of the second patterns pass the actual detectable positions 36P2 and 37P2 of the first registration sensor 36 and the second registration sensor 37. When the first linear portions 82Ka, 82Ca, 82Ma, and 82Ya and 83Ka, 83Ca, 83Ma, and 83Ya pass the detectable positions 36P2 and 37P2, the first registration sensor 36 and the second registration sensor 37 detect the first linear portions 82Ka, 82Ca, 82Ma, and 82Ya and 83Ka, 83Ca, 83Ma, and 83Ya and output the pulse signal PS. Subsequently, the second linear portions 82Kb, 82Cb, 82Mb, and 82Yb and 83Kb, 83Cb, 83Mb, and 83Yb of the second patterns 82K, 82C, 82M, and 82Y and 83K, 83C, 83M, and 83Y pass the detectable positions 36P2 and 37P2 of the first registration sensor 36 and the second registration sensor 37. When the second linear portions 82Kb, 82Cb, 82Mb, and 82Yb and 83Kb, 83Cb, 83Mb, and 83Yb pass the detectable positions 36P2 and 37P2, the first registration sensor 36 and the second registration sensor 37 detect the second linear portions 82Kb, 82Cb, 82Mb, and 82Yb and 83Kb, 83Cb, 83Mb, and 83Yb and output the pulse signal PS.

A method of calculating the color drift amount and an amount of the shift ΔD21 of the pattern formation positions with respect to the detectable positions on the basis of detection results of the first registration sensor 36 and the second registration sensor 37 is explained. The color drift amount and the amount of the shift ΔD21 of the pattern formation positions with respect to the detectable positions are calculated by the calculating unit 103.

Specifically, in order to calculate the color drift amount, first, the calculating unit 103 calculates various pattern intervals ΔD1 and ΔD2 shown in FIGS. 7A and 7B. Specifically, the calculating unit 103 calculates the various pattern intervals from timing of pulse signals output from the first registration sensor 36 and the second registration sensor 37.

The pattern intervals ΔD1 (ΔD1Kf, ΔD1Cf, ΔD1Mf, and ΔD1Yf and ΔD1Kr, ΔD1Cr, ΔD1Mr, and ΔD1Yr in FIGS. 7A and 7B) are intervals in the sub-scanning direction between points where the detectable lines 36L1 and 37L1 of the registration sensors 36 and 37 (if the first pattern is reformed, the detectable lines 36L2 and 37L2) and the first linear portions 72Ka, 72Ca, 72Ma, and 72Ya and 73Ka, 73Ca, 73Ma, and 73Ya cross each other and points where the detectable lines 36L1 and 37L1 (if the first pattern is reformed, the detectable lines 36L2 and 37L2) and the second linear portions 72Kb, 72Cb, 72Mb, and 72Yb and 73Kb, 73Cb, 73Mb, and 73Yb cross each other. Specifically, for example, the pattern intervals ΔD1 (ΔD1Kf, ΔD1Cf, ΔD1Mf, and ΔD1Yf and ΔD1Kr, ΔD1Cr, ΔD1Mr, and ΔD1Yr) are calculated using timing differences Δt1 (Δt1Kf, Δt1Cf, Δt1Mf, and Δt1Yf and Δt1Kr, Δt1Cr, Δt1Mr, and Δt1Yr in FIGS. 7A and 7B) between output timing of the pulse signal PS from the registration sensors 36 and 37 when the sensors 36 and 37 detect the first linear portions 72Ka, 72Ca, 72Ma, and 72Ya and 73Ka, 73Ca, 73Ma, and 73Ya and output timing of the pulse signal PS from the registration sensors 36 and 37 when the sensors 36 and 37 detect the second linear portions 72Kb, 72Cb, 72Mb, and 72Yb and 73Kb, 73Cb, 73Mb, and 73Yb and moving speed V of the transfer belt 10.

The pattern intervals ΔD2 (ΔD2Kf, ΔD2Cf, ΔD2Mf, and ΔD2Yf and ΔD2Kr, ΔD2Cr, ΔD2Mr, and ΔD2Yr in FIGS. 7A and 7B) are intervals in the sub-scanning direction from the first linear portions 72Ya and 73Ya of the first pattern of Y set as a reference to the first linear portions 72Ka, 72Ca, and 72Ma and 73Ka, 73Ca, and 73Ma of the patterns of K, C, and M. Specifically, for example, the pattern intervals ΔD2 (ΔD2Kf, ΔD2Cf, ΔD2Mf, and ΔD2Yf and ΔD2Kr, ΔD2Cr, ΔD2Mr, and ΔD2Yr in FIGS. 7A and 7B) are calculated using timing differences Δt2 (Δt2Kf, Δt2Cf, Δt2Mf, and Δt2Yf and Δt2Kr, Δt2Cr, Δt2Mr, and Δt2Yr in FIGS. 7A and 7B) between output timing of the pulse signal PS from the registration sensors 36 and 37 when the sensors 36 and 37 detect the first linear portions 72Ka, 72Ca, and 72Ma and 73Ka, 73Ca, and 73Ma of the first patterns of M, C, and K and output timing of the pulse signal PS from the registration sensors 36 and 37 when the sensors 36 and 37 detect the first linear portions 72Ya and 73Ya of the first pattern of Y and the moving speed V of the transfer belt 10.

A method of calculating the color drift amount using the various pattern intervals ΔD1 and ΔD2 is explained.

In this embodiment, the calculating unit 103 calculates various color drift amounts, i.e., a color drift amount in the main scanning direction, a color drift amount in the sub-scanning direction, a color drift amount due to a skew, and a color drift amount due to a main scanning magnification.

Specifically, the calculating unit 103 calculates the color drift amount in the main scanning direction, for example, as described below.

Color drift amount of K on the front side=|ΔD1Yf−ΔD1Kf|

Color drift amount of K on the rear side=|ΔD1Yr−ΔD1Kr|

Color drift amount of C on the front side=|ΔD1Yf−ΔD1Cf|

Color drift amount of C on the rear side=|ΔD1Yr−ΔD1Cr|

Color drift amount of M on the front side=|ΔD1Yf−ΔD1Mf|

Color drift amount of M on the rear side=|ΔD1Yr−ΔD1Mr|

The calculating unit 103 calculates the color drift amount in the sub-scanning direction, for example, as described below.

Color drift amount of K on the front side=|ΔD2KYf−ΔD0×3|

Color drift amount of K on the rear side=|ΔD2KYr−ΔD0×3|

Color drift amount of C on the front side=|ΔD2CYf−ΔD0×2|

Color drift amount of C on the rear side=|ΔD2CYr−ΔD0×2|

Color drift amount of M on the front side=|ΔD2MYf−ΔD0|

Color drift amount of M on the rear side=|ΔD2MYr−ΔD0|

ΔD0 is an interval between the first pattern of Y set as the reference and the first pattern of M (equivalent to the interval Dc in FIG. 6B) in an ideal case without a color drift. For example, ΔD0 is stored in the memory 102 in advance as the pattern formation data.

The calculating unit 103 calculates the color drift due to a skew, for example, as described below.

Color drift amount of K=|ΔD2KYf−ΔD2KYr|

Color drift amount of C=|ΔD2CYf−ΔD2CYr|

Color drift amount of M=|ΔD2MYf−ΔD2MYr|

The calculating unit 103 calculates the color drift due to a main scanning magnification, for example, as described below.

Color drift amount of K=|(ΔD1Yf+ΔD1Yr)−(ΔD1Kf+ΔD1Kr)

Color drift amount of C=|(ΔD1Yf+ΔD1Yr)−(ΔD1Cf+ΔD1Cr)

Color drift amount of M=|(ΔD1Yf+ΔD1Yr)−(ΔD1Mf+ΔD1Mr)

A method of calculating the amount of the shift ΔD21 of the pattern formation positions is explained. In the same manner as the calculation of the color drift amounts, first, the calculating unit 103 calculates pattern intervals ΔD4 shown in FIGS. 8A and 8B (ΔD4Kf, ΔD4Cf, ΔD4Mf, and ΔD4Yf and ΔD4Kr, ΔD4Cr, ΔD4Mr, and ΔD4Yr in FIGS. 8A and 8B). Specifically, the calculating unit 103 calculates the pattern intervals ΔD4 (ΔD4Kf, ΔD4Cf, ΔD4Mf, and ΔD4Yf and ΔD4Kr, ΔD4Cr, ΔD4Mr, and ΔD4Yr in FIGS. 8A and 8B) from the moving speed V of the transfer belt 10 and the pulse signal PS output from the registration sensors 36 and 37.

The pattern intervals ΔD4 (ΔD4Kf, ΔD4Cf, ΔD4Mf, and ΔD4Yf and ΔD4Kr, ΔD4Cr, ΔD4Mr, and ΔD4Yr in FIGS. 8A and 8B) are intervals in the sub-scanning direction between points where the detectable lines 36L2 and 37L2 (actual detectable lines) of the registration sensors 36 and 37 and the first linear portions 82Ka, 82Ca, 82Ma, and 82Ya and 83Ka, 83Ca, 83Ma, and 83Ya of the second patterns cross each other and points where the detectable lines 36L1 and 37L1 and the second linear portions 82Kb, 82Cb, 82Mb, and 82Yb and 83Kb, 83Cb, 83Mb, and 83Yb of the second patterns cross each other. For example, the pattern intervals ΔD4 (ΔD4Kf, ΔD4Cf, ΔD4Mf, and ΔD4Yf and ΔD4Kr, ΔD4Cr, ΔD4Mr, and ΔD4Yr in FIGS. 8A and 8B) are calculated using timing differences Δt4 (Δt4Kf, Δt4Cf, Δt4Mf, and Δt4Yf and Δt4Kr, Δt4Cr, Δt4Mr, and Δt4Yr in FIGS. 8A and 8B) between output timing of the pulse signal PS from the registration sensors 36 and 37 when the sensors 36 and 37 detect the first linear portions 82Ka, 82Ca, 82Ma, and 82Ya and 83Ka, 83Ca, 83Ma, and 83Ya and output timing of the pulse signal PS from the registration sensors 36 and 37 when the sensors 36 and 37 detect the second linear portions 82Kb, 82Cb, 82Mb, and 82Yb and 83Kb, 83Cb, 83Mb, and 83Yb and moving speed V of the transfer belt 10.

The calculating unit 103 calculates the amount of the shift ΔD21 of the pattern formation positions with respect to the detectable positions, for example, as described below using the pattern intervals ΔD4 (ΔD4Kf, ΔD4Cf, ΔD4Mf, and ΔD4Yf and ΔD4Kr, ΔD4Cr, ΔD4Mr, and ΔD4Yr in FIGS. 8A and 8B).

Amount of the shift ΔD21 of the first pattern of K on the front side=|ΔD4Kf−ΔD4Y0|

Amount of the shift ΔD21 of the first pattern of K on the rear side=|ΔD4Kr−ΔD4Y0|

Amount of the shift ΔD21 of the first pattern of C on the front side=|ΔD4Cf−ΔD4Y0|

Amount of the shift ΔD21 of the first pattern of C on the rear side=|ΔD4Cr−ΔD4Y0|

Amount of the shift ΔD21 of the first pattern of M on the front side=|ΔD4Mf−ΔD4Y0|

Amount of the shift ΔD21 of the first pattern of M on the rear side=|ΔD4Mr−ΔD4Y0|

Amount of the shift ΔD21 of the first pattern of Y on the front side=|ΔD4Yf−ΔD4Y0|

Amount of the shift ΔD21 of the first pattern of Y on the rear side=|ΔD4Yr−ΔD4Y0|

ΔD4Y0 is equivalent to an interval of the second pattern of the reference color (Y) in the ideal case (without attachment variations of the sensors) and is stored in the memory 102 in advance as, for example, the pattern formation data.

Processing for color drift detection and correction by the control unit is explained with reference to FIG. 9.

First, the CPU 101 sets the color copying machine 1 to a color drift detection correction mode when a power supply for the color copying machine 1 is turned on, during warm-up after paper jam treatment, or making use of paper feed interval timing between image forming processes (ACT 400).

Subsequently, the CPU 101 controls the pattern forming unit using the first pattern formation data to thereby form the first patterns of all the colors (YMCK) on the transfer belt 10 as explained above. Further, as explained above, the registration sensors 36 and 37 detect the formed first patterns.

The calculating unit 103 calculates the various pattern intervals ΔD1 and ΔD2 on the basis of a result of the detection as explained above (ACT 401).

The CPU 101 calculates the various pattern intervals ΔD1 and ΔD2 to thereby determine whether the first patterns of all the colors (YMCK) are successfully detected (ACT 402).

If the first patterns of all the colors (YMCK) are successfully detected as a result of the determination, the calculating unit 103 calculates the various color drift amounts using the calculated various pattern intervals ΔD1 and ΔD2 as explained above (ACT 403).

Further, the CPU 101 determines whether the calculated various color drift amounts are within a predetermined target value (ACT 404).

If the calculated various color drift amounts are within the predetermined target value, the CPU 101 performs color drift correction using the various color drift amounts as correction values and sets the color copying machine 1 to a normal image formation mode for printing an image on paper. Consequently, the color drift correction mode is completed (ACT 405).

If the calculated various color drift amounts are not within the predetermined target value in ACT 404, the CPU 101 performs the processing in ACT 401 to ACT 403 again. If the CPU 101 determines that the calculated various color drift amounts are not within the target value in ACT 404 even if the processing in ACT 401 to ACT 403 is repeated a predetermined number of times (ACT 406), the CPU 101 shifts to an error routine and ends the processing of the color drift correction determining that an error occurs (ACT 431).

If the CPU 101 determines in ACT 402 that the first patterns of all the colors (YMCK) are not successfully detected, the CPU 101 determines whether the first pattern not successfully detected is the first pattern of the reference color (Y) (ACT 411).

If the CPU 101 determines as a result of the determination that the first pattern of the reference color (Y) is not successfully detected, the CPU 101 controls the pattern forming unit using the second pattern formation data to thereby form the second pattern of Y on the transfer belt 10. The CPU 101 detects the formed second pattern using the registration sensors 36 and 37. The calculating unit 103 calculates the pattern interval ΔD4 on the basis of a result of the detection and calculates amounts of the shift ΔD21 of the pattern formation positions using the calculated pattern interval ΔD4 (ACT 412).

The CPU 101 determines whether the calculated amounts of the shift ΔD21 are within the predetermined target value (ACT 413).

If the CPU 101 determines that the calculated shift amounts of the detectable positions are within the target value, using the shift amounts of the detectable positions as correction values, the CPU 101 corrects the formation start timing data in the main scanning direction of the first pattern formation data (ACT 414). Processing performed by the CPU 101 thereafter returns to the processing in ACT 401.

If the CPU 101 determines in ACT 413 that the calculated amounts of the shift ΔD21 are not within the predetermined target value, the CPU 101 shifts to an error routine and ends the processing of the color drift correction determining that an error occurs (ACT 431).

If the CPU 101 determines as a result of the determination in ACT 411 that the first patterns of the colors (M, C, and K) other than the reference color (Y) are not successfully detected, the CPU 101 controls the pattern forming units using the second pattern formation data to thereby form the second patterns of the undetected colors (M, C, and K) on the transfer belt 10. The CPU 101 detects the formed second patterns using the registration sensors 36 and 37. The calculating unit 103 calculates the pattern interval ΔD4 on the basis of a result of the detection and calculates shift amounts of the detectable positions using the calculated pattern interval ΔD4 (Act 421).

The CPU 101 determines whether the calculated values of the shift ΔD21 are within the predetermined target value (ACT 422).

If the CPU 101 determines that the calculated amounts of the shift ΔD21 are within the target value, using the calculated amounts of the shift ΔD21 as correction values, the CPU 101 corrects the formation start timing data in the main scanning direction of the first pattern formation data (Act 423). Thereafter, the processing by the CPU 101 returns to the processing in ACT 401.

If the CPU 101 determines in ACT 422 that the calculated amounts of the shift ΔD21 are not within the target value, the CPU 101 shifts to an error routine and ends the processing of the color drift correction determining that an error occurs (ACT 431).

As explained above, in this embodiment, first, the pattern forming unit forms the first pattern having a predetermined size in a predetermined position of the transfer medium. The pattern detecting unit detects the first pattern. The control unit calculates various color drift amounts using a result of the detection of the first pattern. At this point, if the pattern detecting unit may be unable to detect the first pattern, the pattern forming unit forms the second pattern having a size larger than the first pattern in the predetermined position of the transfer medium. The pattern detecting unit detects the second pattern. The control unit calculates an amount of the shift ΔD21 of the first pattern formation position with respect to the detectable position using a result of the detection of the second pattern. The control unit sets, as a correction value, the calculated amount of the shift ΔD21 of the first pattern formation position with respect to the detectable position. The pattern forming unit reforms the first pattern in a corrected position of the transfer medium. The control unit calculates various color drift amounts on the basis of a result of detection of the reformed first pattern.

In this embodiment, the patterns of the wedge shape are used as the first pattern and the second pattern. However, the shape of the first pattern and the second pattern is not limited to the wedge shape and may be various shapes.

In this embodiment, a method of calculating the color drift amount is not limited to the method explained above. As the method of calculating the color drift amount, various well-known methods can be applied according to a combination of the shape of the first pattern and the second pattern, the position of the pattern detecting unit, and the like.

In this embodiment, the color drift correction is performed using the color drift amount as a correction amount. However, as a method of performing the color drift correction, various well-known methods can be applied.

In this embodiment, a method of calculating an amount of the shift ΔD21 of the first pattern formation position with respect to the detectable position is not limited to the method explained above. The method of calculating an amount of the shift ΔD21 of the first pattern formation position with respect to the detectable position may be changed according to a combination of the shape of the first pattern and the second pattern, the position of the sensor, and the like.

In this embodiment, the color copying machine including the scanner unit 6 is explained as the color image forming apparatus. However, this is not a limitation. For example, the color image forming apparatus may be an apparatus that does not include the scanner unit 6 and forms an image on sheet paper on the basis of image data of the colors obtained via a network.

In this embodiment, the apparatus is explained that sequentially transfers images of the colors Y, M, C, and K onto sheet paper conveyed by the transfer belt and forms a color image obtained by superimposing the images of the colors one on top of another on the sheet paper. However, this is not a limitation. For example, the color image forming apparatus may be an apparatus that sequentially superimposes images of the colors Y, M, C, and K one top of another to once to form a color image on the transfer belt and transfers the color image onto sheet paper.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A color image forming apparatus that superimposes images of plural colors one on top of another on a transfer medium to form a color image, the color image forming apparatus comprising:
a pattern forming unit configured to form, on a transfer medium, a first pattern for detecting a color drift of the images to be superimposed one on top of another or a second pattern different from the first pattern;
a pattern detecting unit configured to detect the first pattern and the second pattern formed by the pattern forming unit; and
a control unit configured to control the pattern forming unit to form the first pattern on the transfer medium in order to detect a color drift of the images to be superimposed one on top of another and, if the first pattern is not detected by the pattern detecting unit, form the second pattern on the transfer medium and reform the first pattern using a result of the detection of the second pattern by the pattern detecting unit.

2. The apparatus according to claim 1, wherein the second pattern has a size larger than a size of the first pattern and has a shape same as a shape of the first pattern.

3. The apparatus according to claim 2, wherein the pattern detecting unit detects the first pattern and the second pattern in a same position.

4. The apparatus according to claim 3, wherein the size of the second pattern is large enough to be detectable by the detecting unit even if the first pattern is not detected by the pattern detecting unit.

5. The apparatus according to claim 1, wherein the second pattern has a first linear portion and a second linear portion, and one ends of the first linear portion and the second linear portion cross each other to form a wedge shape.

6. The apparatus according to claim 5, wherein the pattern forming unit forms the second pattern on the transfer medium such that the first linear portion of the second pattern extends along a direction orthogonal to a moving direction of the transfer medium.

7. The apparatus according to claim 1, wherein, if the first pattern is not detected by the pattern detecting unit, the control unit controls the pattern forming unit to change a position on the transfer medium using a result of the detection of the second pattern and reform the first pattern.

8. The apparatus according to claim 1, if the first pattern is not detected by the pattern detecting unit, the control unit controls the pattern forming unit to change a position on the transfer medium in a direction orthogonal to a moving direction of the transfer medium using a result of the detection of the second pattern and reform the first pattern.

9. The apparatus according to claim 1, wherein the control unit includes a correcting unit configured to calculate, if the first pattern is not detected by the pattern detecting unit, using a result of the detection of the second pattern, a correction value for correcting a shift of a formation position of the first pattern with respect to a detectable position of the pattern detecting unit.

10. The apparatus according to claim 9, wherein, if the first pattern is not detected by the pattern detecting unit, the control unit controls, on the basis of the correction value for correcting the shift of the formation position calculated by the correcting unit, the pattern forming unit to reform the first pattern.

11. The apparatus according to claim 6, wherein the pattern detecting unit is located in a position on a downstream side in the moving direction of the transfer medium and detects timing when the first linear portion and the second linear portion of the second pattern pass a detectable position of the pattern detecting unit according to the movement of the transfer medium.

12. The apparatus according to claim 1, wherein, if the first pattern reformed by the pattern forming unit using a result of the detection of the second pattern by the pattern detecting unit is not detected by the pattern detecting unit, the control unit stops, determining that an error occurs, processing for correcting the color drift of the images to be superimposed one on top of another.

13. The apparatus according to claim 2, wherein the pattern forming unit forms the first pattern on a detectable line that passes a detectable position on the transfer medium of the pattern detecting unit, which is attached to a predetermined position, and extends along a moving direction of the transfer medium.

14. The apparatus according to claim 13, wherein, if the first pattern is not detected by the pattern detecting unit, the pattern forming unit forms the second pattern on the detectable line.

15. The apparatus according to claim 9, wherein the correcting unit calculates, using a result of the detection of the first pattern by the pattern detecting unit, a correction value for correcting the color drift of the images to be superimposed one on top of another.

16. A color image forming apparatus that superimposes images of plural colors one on top of another on a transfer medium to form a color image, the color image forming apparatus comprising:
a pattern forming unit configured to form, on a transfer medium, a first pattern for detecting a color drift of the images to be superimposed one on top of another or a second pattern having a size larger than a size of the first pattern and having a shape same as a shape of the first pattern;
a pattern detecting unit configured to detect the first pattern and the second pattern formed by the pattern forming unit;
a memory unit configured to store first pattern formation data necessary to form, with the pattern forming unit, the first pattern on a detectable line that includes a detectable position of the pattern detecting unit, which is attached to a predetermined position, and extends along a moving direction of the transfer medium and second pattern formation data necessary to form, with the pattern forming unit, the second pattern on the detectable line; and
a control unit configured to control the pattern forming unit to form the first pattern on the transfer medium using the first pattern formation data stored in the memory unit and, if the first pattern is not detected by the pattern detecting unit, form the second pattern on the transfer medium using the second pattern formation data stored in the memory unit and reform the first pattern using a result of the detection of the second pattern by the pattern detecting unit and the first pattern formation data.

17. A color image forming method for superimposing images of plural colors one on top of another on a transfer medium to form a color image, the color image forming method comprising:
a pattern forming unit forming, on the transfer medium, a first pattern for detecting a color drift of the images to be superimposed one on top of another;
a pattern detecting unit performing detection of the first pattern;
the pattern forming unit forming, if the first pattern is not detected as a result of the detection of the first pattern, a second pattern different from the first pattern on the transfer medium;
the pattern detecting unit performing detection of the second pattern; and
the pattern forming unit reforming the first pattern on the transfer medium using a result of the detection of the second pattern.

18. The method according to claim 17, wherein the second pattern has a size larger than a size of the first pattern and has a shape same as a shape of the first pattern.

19. The method according to claim 18, wherein the reforming the first pattern includes calculating a correction value for correcting, using a result of the detection of the second pattern, a shift of a formation position of the first pattern with respect to a detectable position of the pattern detecting unit.

20. The method according to claim 19, wherein the reforming the first pattern includes changing the formation position of the first pattern on the basis of the correction value to reform the first pattern.
